(19) United States
(12) Patent Application Publication
(10) Pub. No.: US 2008/0020284 A1
(43) Pub. Date: Jan. 24, 2008

(54) Polymeric Binder for Fused Salts Electrolytes Based Batteries

(75) Inventors: Christophe Michot, Montreal (CA); Gerald Perron, Boucherville (CA); Junzo Ukai, Ann Harbor, MI (US); Wen Li, Ann Harbor, MI (US); Keiichi Kohama, Mishima-shi (JP); Yutaka Oyama, Toyota-shi (JP); Shoji Yokoishi, Mishima-shi (JP)

Correspondence Address: FULBRIGHT & JAWORSKI L.L.P., 600 CONGRESS AVE., SUITE 2400, AUSTIN, TX, 78701, US

(73) Assignees: UNIVERSITE DE MONTREAL, Quebec (CA); CENTRE NATIONAL DE LA RECHERCE SCIENTIFIQUE, Paris (FR)

(21) Appl. No.: 10/554,888

(22) PCT Filed: Apr. 30, 2004
(86) PCT No.: PCT/CA04/00660

§ 371 Date: Jul. 18, 2007

(30) Foreign Application Priority Data
Apr. 30, 2003 (CA) 2427111

(51) Int. Cl. H01M 4/02; C08G 83/00; H01M 4/62; H01M 6/04

(52) U.S. Cl. 429/325; 252/500; 252/520.21; 252/521.2; 528/401

(57) ABSTRACT

The present invention relates to polymeric binders of formula: [(—CH₂CF₂—)_{x′}(—CF₂CF₂—)_{y′}[—CH₂CH(R)—]_{z′}]ₘ wherein: x′+y′+z′=1, only one x′, y′ or z′ could be simultaneously equal to zero; R is an alkyl radical CₙH₂ₙ₊₁— with 0≦n≦8, 10≦m≦10⁶.

### FIELD OF THE INVENTION

The present invention relates to polymeric binder for fused salts electrolytes-based batteries and to polymeric binder for ionic liquids based batteries. The present invention also more particularly relates to polymeric binders for the preparation of high performance electrodes used in organic ionic liquids electrolytes based batteries.

### BACKGROUND OF THE INVENTION

Numerous industrial fields need batteries as portable power sources, such batteries must have high performance, reduced sizes and a high level of security.

Lithium batteries, either primary or secondary, have been developed and now use as the main power sources in high volume applications mainly for consumer electronics (e.g., phone, camera, laptop, etc.).

Those batteries use a positive electrode such as, for example, vanadium pentoxide V₂O₅, manganese oxide MnO₂, lithium cobaltate LiCoO₂, lithium nickelate LiNiO₂ and spinel type lithium manganate LiMn₂O₄. The negative electrode is made, for example, of metallic lithium, or carbon material, such as graphite or coke. The electrolyte is made of a lithium salt, for example, LiPF₆, dissolved in a solvent or a mixture of solvents chosen, for example, from organic solvent such as propylene carbonate, ethylene carbonate, dimethyl carbonate, dimethoxyethane, butyrolactones, dimethyl sulfone, etc. Accurate combination allows the fabrication of high voltage, high energy density batteries commonly used on the market.

Outside of consumer electronics, a huge amount of research and development (R&D) activities has been performed for more than ten years in order to develop high energy density secondary batteries for electric vehicles and hybrid electric vehicles. For such applications, it is necessary to dispose of large high energy density batteries of a few kilograms up to 100-200 kilograms. In this case, existing lithium batteries using liquid organic solvent as the electrolyte failed-to ensure a security level matching automotive manufacturer's requirements.

In view to improve security of the lithium batteries, liquid organic electrolytes have been replaced by dry polymers electrolytes in lithium batteries using metallic lithium as the anode. Such electrolytes use solvents like polyethylene oxide with a dissociated lithium salt dissolve in it to obtain the desired polymeric electrolyte. However, even if this technology allows producing safe batteries, it is necessary to warm the battery in the 60° C. range to provide a sufficient cycling and power performances in range with automotive manufacturer's expectations.

An alternative, which combines lower operating temperatures and safety, is to use as the electrolytes a low basicity lithium salt dissolved in an ionic liquid. Such electrolytes in addition to be highly conductive are, contrary to usual organic solvents, non-flammable and non-volatile, allowing a high level of safety in accordance with automotive applications requirements (Electric and Hybrid vehicles).

Such ionic liquids are usually an onium like compound, such as for example, but not limited to, an ammonium, a pyrrolidinium, a phosphonium, an oxonium, a sulfonium, an amidinium, a guanidinium, an isouronium, an imidazolium, a pyrazolium combined with a low basicity anion such as for example, but not limited to, PF₆⁻, BF₄⁻, CF₃SO₃⁻, (CF₃SO₂)₂N⁻, (FSO₂)₂N⁻. Those ionic liquids differ strongly from classical organic solvents especially in terms of polarity, viscosity and solvating properties of organic species, polymers and salts.

Due to their poor stability to reductive potential, above metallic lithium potential, such ionic liquids electrolytes are combined with higher voltage insertion anode, typically lithium titanate spinel Li₄Ti₅O₁₂, working at potential superior to 1 Volt vs lithium.

Another major constraint of such “ideal” automotive batteries is the requirement to work at temperatures of between typically about −30° C. and 80° C., since the high power drain required for regenerative breaking implied a warming of the battery and the low temperature limit is necessary for cold working conditions.

The development of such batteries implied intensive R&D to develop and identify the specific materials able to meet the performance criteria of ionic liquids electrolytes.

Since the ionic liquids are liquid media, it is necessary to develop suitable porous electrodes for battery anode and cathode. The electrodes usually comprise three components: an insertion compound able to insert and release lithium cation (i.e, electroactive compound), a conductivity enhancer such as carbon black or graphite and a binder to maintain mechanical integrity of the electrodes.

Binder is a key component of an electrode. It may more particularly be chemically and electrochemically stable with respect to the battery operation conditions and with respect to components. It may also more particularly be non-soluble in electrolyte and soluble in a desired solvent for processing by coating technology.

Poly(vinylidene fluoride) (PVDF) and its copolymer with hexaflubropropylene PVDF-HFP Poly(vinylidene fluoride-co-hexafluoropropylene), are commonly used as binder in the field of Li-Ion batteries for more than ten years due to their good chemical and electrochemical properties. In the case of such alternative technology to Li-Ion based on ionic liquids, some limitations in the use of PVDF based polymers have been identified. Improvements in PVDF based polymer binder are therefore needed.

### GENERAL DESCRIPTION

The various alternative binders has been qualified by preparing both anode and cathode electrode by coating technology with those binders and assembling batteries using one anode, one cathode, a separator and an electrolyte obtained by dissolution of low basicity lithium salt in an organic ionic liquids. Thus, batteries test such as cycling performance at different temperatures and power properties has been performed. Both anode and cathode are porous composite electrode containing an electroactive compound, a carbon conductivity enhancer and a binder.

The anodic electroactive compound may be able to insert reversibly lithium during reduction at potential<2 vs Li⁺/Li⁰, this is obtained, but not limited to, with oxide comprising a titanium spinel Li_{4x+3y}Ti₅₋ₓO₁₂ wherein 0≦x, y≦1, or an oxide Li[Ti_{1.67}Li_{0.33-y}M_{y}]O₄ wherein 0≦y≦0.33 and wherein M=Mg and/or Al in which the M cations are partially replaced by one or more suitable monovalent, divalent, trivalent-or tetravalent metal M′ cations to provide an electrode Li[Ti_{1.67}Li_{0.33-y}M_{y-z}M′_{z}]O₄ in which z<y, or a double nitride of a transition metal and lithium comprising Li₃₋ₓCo₂N wherein 0≦x≦1 or having a structure of the antifluorite type comprising Li₃FeN₂ or Li₇MnN₄, or MoO₂, or WO₂, or mixtures thereof.

Li₄Ti₅O₁₂ in the form of microsized (≈5 μm diameter) or nanosized (≈40 nm) electroactive material has particularly been used to qualify the binder.

The cathodic electroactive compound may be able to release reversibly lithium during oxydation at potential>2 vs Li⁺/Li⁰, this is obtained, but not limited to, with double oxide of cobalt and lithium optionally partially substituted of general formula Li₁₋ₐCo_{1-x+y}NiₓAl_{y}O₂ wherein 0<x+y<1; 0<y<0.3; 0<a<1 , or Li_{y}N_{1-x-z}CoₓAl_{z}O₂ wherein 0≦x+y≦1 and 0≦y≦1 , or a manganese spinel Li₂Mn₂₋ₓMₓO₄ wherein M is Cr, Al, V, Ni; 0≦x≦0.5, or a double phosphate of the Olivine or Nasicon structure comprising Li₁₋ₐFe₁₋ₓMnₓPO₄ and Li₁₋ₓ₊₂ₐFe₂P₁₋ₓSiₓO₄ wherein 0<x, a<1, or LiCoPO₄ wherein Co could be substituted by one or more suitable metal cation, or LiNiO₂ wherein Ni could be substituted by one or more suitable metal cation, or a mixtures thereof.

LiCoO₂ in the form of microsized (≈5 μm diameter) or nanosized (≈40 nm) electroactive material has particularly been used to qualify the binder.

The carbon conductivity enhancer is chosen from carbon black or graphite in the form of fiber or powder, or mixture thereof. Shawinigan Black® (CPChem) powder of 40 nm diameter, an equivalent with 300 nm diameter, or Ketjenblack® (Akzo) has particularly been used to qualify the binder.

As substitute for PVDF or PVDF-HFP binder, the use of polymer of general formula:

[(—CH₂CF₂—)_{x′}(—CF₂CF₂—)_{y′}[—CH₂CH(R)—]_{z′}]ₘ whereas:
x′+y′+z′=1
only one x′, y′ or z′ could be simultaneously equal to zero
R is an alkyl radical CₙH₂ₙ₊₁— with 0≦n≦8
10≦m≦10^{6,}
   was tested.

Polymers are particularly selected such that the total mass>30000 (daltons). For example, copolymer of tetrafluoroethylene and polypropylene or ethylene and terpolymer of tetrafluoroethylene, vinylidene fluoride and polypropylene are commonly used industrial polymer available from Aldrich company.

For each electrode, electroactive material, conductivity enhancer and binder are thoroughly mixed in a solvent or a mixture of solvent to obtain a finely dispersed suspension. This dispersion could be performed with mechanical grinding, either manually in a mortar or with a ball mill. This suspension is then coated on a conductive current collector with a blade applicator. The solvent is such that the bonder is soluble in it and stable to electroactive species. 1-Methyl-2-pyrrolidone (NMP) has particularly been used as solvent. After drying in air, the electrode has been dry under vacuum at 60-100° C. during 24 hours and store in a glove box under helium. As current collector, it is possible to used metal foil such as stainless steel, molybdenum, aluminum but aluminum double side coated with acrylate based polymers charged with carbon powder (Intellicoat, Product Code 2651) has particularly been used.

A typical composition for those electrodes is 85% wt electroactive compounds, 5% wt binder and 10% wt carbon. The composition of the binder is particularly between 5 and 15% wt and carbon between 5 and 10% wt. It is to be understood that the % wt is expressed with respect to the total weight of the composition.

As separator intercalate between both electrodes, porous polymer film of 10-30 μm, such as porous polyolefin (Celgard®) or alkylated cellulose may be used. In other embodiment, the separator is a gel electrolyte between a polymer and the organic ionic liquids.

The electrolyte, which filled the porous electrode and the separator, is a combination of:

at least one ionic compound having one cation of the onium type with at least one heteroatom comprising N, O, S or P bearing a positive charge and the anion including, in whole or in part, at least one imide ion choose from (FSO₂)₂N⁻ and (CF₃SO₂)₂N⁻, or a mixtures thereof; and

at least one other component comprising a metallic salt and eventually an aprotic co-solvent with a boiling point>150° C.

The onium could be choose in particular from ammonium (R₄N⁺), phosphonium (R₄P⁺), oxonium (R₃O⁺), sulfonium (R₃S⁺), guanidinium [(R₂N)₃C⁺], amidinium [(R₂N)₂C⁺R′], imidazolium [(RN)₂(CR′)₃], pyrazolium [(RN)₂(CR′)₃], or a mixture thereof, wherein:

R are independently choose from:

an alkyl, alkenyl, oxaalkyl, oxaalkenyl, azaalkyl, azaalkenyl, thiaalkyl, thiaalkenyl, dialkylazo, each of these can be either linear, branched or cyclic and comprising from 1 to 18 atoms;

cyclic or heterocyclic aliphatic radicals of from 4 to 26 carbon atoms optionally comprising at least one lateral chain comprising one or more heteroatoms;

aryl, arylalkyl, alkylaryl and alkenylaryl of from 5 to 26 carbon atoms optionally comprising one or more heteroatoms in the aromatic nucleus;

groups comprising aromatic or heterocyclic nuclei, condensed or not, optionally comprising one or more atoms of nitrogen, oxygen, oxygen, sulfur or phosphorus;

and wherein two adjacent groups R can form a cycle or a heterocycle of from 4 to 9 carbon atoms, and wherein one or more R groups on the same cation can be part of polymeric chain;

and wherein R′ is H or R as defined above.

Thus in view of the matters described herein the present invention provides in one aspect thereof an electrode material (e.g., for use in organic ionic liquids electrolyte based electrochemical battery (generator)) comprising at least:
one electroactive compound;
one carbonaceous conductivity enhancer, and;
one polymeric binder of formula;

[(—CH₂CF₂—)_{x′}(—CF₂CF₂—)_{y′}[—CH₂CH(R)—]_{z′}]ₘ
wherein each of x′, y′ or z′ is selected from the group consisting of positive values<1 and 0, provided that only one of x′, y′ and z′ may have a value of 0 at any given time,
wherein R is an alkyl radical of formula: CₙH₂ₙ₊₁— wherein 0≦n≦8, and;
wherein 10≦m≦10⁶.

In other words, it is to be understood from the above, that;

0≦x′<1;

0≦y′<1;

0≦z′<1;

provided that only one of x′, y′ or z′ may be 0 at one given time.

In accordance with the present invention x′, y′ and z′ may be comprised between 0.05 to 0.95 (i.e., from 0.05 to 0.95).

In accordance with the present invention (—CF₂CF₂—) may account for 45-65% wt, (—CF₂CH₂—) may account for 15-35% wt, [—CH₂CH(R)—] may account for 5-25% wt and R may be H or CH₃. It is to be understood that the % wt is expressed with respect to the total weight of the binder.

In accordance with the present invention, one of x′, y′ or z′ may be equal to zero.

In accordance with the present invention, one of x′ or y′ is 0 and z′ may be comprised between 0.05 and 0.95 (i.e., z′ may be selected from 0.05 to 0.95).

In accordance with the present invention, R may be selected from the group consisting of H and CH₃ (i.e, n is 0 or 1) and [—CH₂CH(R)—] may account for 10-90% wt. It is to be understood that the % wt is expressed with respect to the total weight of the binder.

In accordance with the present invention z′ may be 0 and x′ may be comprised between 0.05 and 0.95. (i.e., x′ may be selected from 0.05 to 0.95)

In accordance with the present invention, R may be selected from the group consisting of H and CH₃ (i.e, or n is 0 or 1) and (—CF₂CF₂—) may account for 10-90% wt. It is to be understood that the % wt is expressed with respect to the total weight of the binder.

In accordance with the present invention the electroactive compound may be able of inserting and releasing lithium cation at a potential≦2 Volts vs Li⁺/Li⁰, forming a negative electrode (anode).

In accordance with the present invention, the electroactive compound may be an oxide comprising a titanium spinel Li_{4x+3y}Ti₅₋ₓO₁₂ wherein 0≦x, y≦1, or an oxide Li[Ti_{1.67}Li_{0.33-y}M_{y}]O₄ wherein 0≦y≦0.33 and wherein M=Mg and/or Al in which optionally if so desired the M cations may be partially replaced by one or more suitable monovalent, divalent, trivalent or tetravalent metal M′ cations to provide an electrode Li[Ti_{1.67}Li_{0.33-y}M_{y-z}M′_{z}]O₄ in which z<y, or a double nitride of a transition metal and lithium comprising Li₃₋ₓCo₂N wherein 0≦x≦1 or having a structure of the antifluorite type comprising Li₃FeN₂ or Li₇MnN₄, or MoO₂, or WO₂, or mixtures thereof. M may therefore be Mg alone, Al alone and a mixture of Mg and Al alone and optionally Mg with a M′ cation, Al with a M′ cation and the like. M′ may, for example, be vanadium, manganese, etc.

In accordance with the present invention, the electroactive compound may be able of inserting and releasing lithium cation at a potential≧2 Volts vs Li⁺/Li⁰, forming a positive electrode (cathode).

In accordance with the present invention, the electroactive compound may be a double oxide of cobalt and lithium optionally partially substituted selected from the group consisting of
Li₁₋ₐCo_{1-x+y}NiₓAl_{y}O₂ wherein 0<x+y<1; 0<y<0.3; 0<a<1;
Li_{y}N_{1-x-z}CoₓAl_{z}O₂ wherein 0≦x+y≦1 and 0≦y≦1,
a manganese spinel of formula: Li₂Mn₂₋ₓMₓO₄ wherein M is Cr, Al, V, Ni; 0≦x≦0.5,
a double phosphate of the Olivine or Nasicon structure comprising
Li₁₋ₐFe₁₋ₓMnₓPO₄,
Li₁₋ₓ₊₂ₐFe₂P₁₋ₓSiₓO₄ wherein 0<x, a<1,
LiCoPO₄ wherein Co is substitutable by one or more suitable metal cation,
LiNiO₂ wherein Ni is substitutable by one or more suitable metal cation, and;
mixtures thereof.

In accordance with the present invention, the size of a particle of the electroactive compound may have a mean diameter size of between 10 nm and 30 μm.

In accordance with the present invention, the carbonaceous conductivity enhancer may be, for example, selected from the group consisting of a carbon black, a graphite and the like. The carbonaceous conductivity enhancer may be in the form of a powder, a fiber, or a mixture thereof. In accordance with the present invention, the size of a particle of the carbonaceous conductivity enhancer may have mean diameter of between 10 nm and 30 μm (i.e., from 10 nm and 30 μm).

In accordance with the present invention, the electroactive material may account for 45 to 95% wt, and the carbonaceous conductivity enhancer may account for 3 to 30% wt and wherein the polymeric binder accounts for 3 to 30% wt. The % wt is expressed here with respect to the total weight of the electrode material.

In accordance with the present invention, the porosity of the electrode material may be comprised between 30 and 300% (i.e., porosity may fall in the range of from 30 to 300%). The porosity may be calculated according to the following formula: (Vm−Vcalc)/Vcalc×100

Vm=measured volume of the electrode

Vcalc.=the sum of the calculated volumes of each of the components of the electrode material, each component volume being determined by dividing the mass of the component of the electrode by the density of such component.

In accordance with the present invention, the porosity may be adjusted by a lamination process.

The present invention further provides in one aspect a method of preparing an electrode the method may be performed by coating technology from a suspension comprising a electroactive compound, a carbonaceous conductivity enhancer, and a polymeric binder, the suspension may be in a solvent, or a mixture of solvent, the polymeric binder may be soluble (i.e., the solvent may be able to solubilize the polymeric binder or the suspension).

In accordance with the present invention the electrode material may be coated on a current collector. The current collector may be, for example, aluminum.

The present invention provides in a further aspect thereof, an electrochemical battery (i.e., generator) which may comprise at least one electrode material or a binder as defined herein.

In accordance With the present invention, the electrochemical battery (i.e., generator) may comprise a first (positive) electrode as defined herein, a second (negative) electrode as defined herein, and a separator in between the first and second electrodes and the first and second electrodes and separator may be filled with an organic ionic liquid electrolyte.

In accordance with the present invention, the electrolyte may comprise,
one or at least one ionic compound having one cation of the onium type having at least one heteroatom comprising N, O, S or P bearing a positive charge and an anion including, in whole or in part, at least one imide ion which may be selected from the group consisting of (FSO₂)₂N⁻, (CF₃SO₂)₂N⁻, and mixtures thereof; and
one or at least one other component comprising a metallic salt and eventually an aprotic co-solvent having a boiling point>150° C.

In accordance with the present invention, the separator may be a porous polymer matrix or a gel formed, for example, from a polymer and an organic ionic liquid electrolyte.

In accordance with the present invention, the onium may be selected, for example, from the group consisting of an ammonium of formula: R₄N⁺, a phosphonium of formula: R₄P⁺, an oxonium of formula: R₃O⁺, a sulfonium of formula: R₃S⁺, a guanidinium of formula: (R₂N)₃C⁺, an amidinium of formula: (R₂N)₂C⁺R′, an imidazolium of formula: (RN)₂(CR′)₃, a pyrazolium of formula: (RN)₂(CR′)₃, a pyrolidinium of formula: (R₂N(CR′)₃ and a mixture thereof, and;

each R is independently chosen from
an alkyl, alkenyl, oxaalkyl, oxaalkenyl, azaalkyl, azaalkenyl, thiaalkyl, thiaalkenyl, dialkylazo, each of these may be either linear, branched or cyclic and comprising from 1 to 18 atoms;
cyclic or heterocyclic aliphatic radicals of from 4 to 26 carbon atoms optionally comprising at least one lateral chain which may comprise one or more heteroatoms;
aryl, arylalkyl, alkylaryl and alkenylaryl of from 5 to 26 carbon atoms which may optionally comprise one or more heteroatoms in the aromatic nucleus;
groups comprising aromatic or heterocyclic nuclei, condensed or not, optionally comprising one or more atoms of nitrogen, oxygen, oxygen, sulfur or phosphorus;
and wherein two adjacent groups R can form a cycle or a heterocycle of from 4 to 9 carbon atoms, and wherein one or more R groups on the same cation can be part of polymeric chain;
and wherein R′ is H or R as defined herein.

In accordance with the present invention, the metallic salt may be selected from the group consisting of LiN(FSO₂)₂ and LiN(CF₃SO₂)₂.

In yet a further aspect, the present invention provides a polymeric binder of
formula; [(—CH₂CF₂—)_{x′}(—CF₂CF₂—)_{y′}[—CH₂CH(R)—]_{z′}]ₘ
wherein each of x′, y′ or z′ may be selected from the group consisting of positive values<1 and 0, and only one of x′, y′ and z′ may have a value of 0,
wherein R may be an alkyl radical of formula CₙH₂ₙ₊₁, and may be 0≦n≦8
wherein 10≦m≦10⁶
   wherein swelling of the binder in an organic ionic liquid may be less than 5% (with respect to its initial volume).

In yet an additional aspect, the present invention provides a polymeric binder of
formula [(—CH₂CF₂—)_{x′}(—CF₂CF₂—)_{y′}[—CH₂CH(R)—]_{z′}]ₘ
wherein each of x′, y′ or z′ may be selected from the group consisting of positive values<1 and 0, and only one of x′, y′ and z′ may have a value of 0,
wherein R may be an alkyl radical of formula CₙH₂ₙ₊₁, wherein 0≦n≦8
wherein 10≦m≦10⁶
wherein swelling of the binder in an organic ionic liquid may be less than 2% (with respect to its initial volume).

In accordance with the present invention (—CF₂CF₂—) may account for 45-65% wt, (—CF₂CH₂—) may account for 15-35% wt, [—CH₂CH(R)—] may account for 5-25% wt and R may be H or CH₃.

The present invention provides in another aspect, the use of a polymeric binder of formula;

[(—CH₂CF₂—)_{x′}(—CF₂CF₂—)_{y′}[—CH₂CH(R)—]_{z′}]ₘ

more particularly in the preparation of an electrode or a battery,
wherein each of x′, y′ or z′ may be selected from the group consisting of positive values<1 and 0, and only one of x′, y′ and z′ may have a value of 0 at any given time,

wherein R may be an alkyl radical of formula: CₙH₂ₙ₊₁— wherein 0≦n≦8, and;

wherein 10≦m≦10⁶.

In accordance with the present invention, for the binder for use in the electrode or battery of the present invention, x′ may be 0.273, y′ may be 0.576, z′ may be 0.151 and R may be 3. In accordance with the present invention, m is such that the molecular weight of said polymer is about 30000 (daltons).

It is to be understood herein, that if a “range”, “group of substances” or particular characteristic (e.g., temperature, concentration, time and the like) is mentioned, the present invention relates to and explicitly incorporates herein each and every specific member and combination of sub-ranges or sub-groups therein whatsoever. Thus, any specified range or group is to be understood as a shorthand way of referring to each and every member of a range or group individually as well as each and every possible sub-ranges or subgroups encompassed therein; and similarly with respect to any sub-ranges or sub-groups therein. Thus, for example,
with respect to the number of carbon atoms, the mention of the range of 1 to 6 carbon atoms is to be understood herein as incorporating each and every individual number of carbon atoms as well as sub-ranges such as, for example, 1 carbon atoms, 3 carbon atoms, 4 to 6 carbon atoms, etc.
with respect to reaction time, a time of 1 minute or more is to be understood as specifically incorporating herein each and every individual time, as well as sub-range, above 1 minute, such as for example 1 minute, 3 to 15 minutes, 1 minute to 20 hours, 1 to 3 hours, 16 hours, 3 hours to 20 hours etc.;
and similarly with respect to other parameters such as concentrations, elements, etc. . . .

It is thus to be understood herein that a “alkyl radical CₙH₂ₙ₊₁ wherein 0≦n≦8” includes for example, without limitation, methyl, ethyl, propyl, pentyl, hexyl, heptyl, octyl, iso-butyl, tert-butyl, 2-pentyl (i.e. 2-methyl-butyl), 3-pentyl (i.e. 3-methyl-butyl; isopentyl), neopentyl, tert-pentyl etc.

It is in particular to be understood herein that the compound formulae each include each and every individual compound described thereby as well as each and every possible class or sub-group or sub-class of compounds whether such class or sub-class is defined as positively including particular compounds, as excluding particular compounds or a combination thereof; for example an exclusionary definition for the formulae (e.g. I) may read as follows: “provided that when x′ is 0, n cannot be 0” or “provided that when x′ is 0, n cannot be 1” or “provided that when x′ is 0, n cannot be 0 or 1”.

It is also to be understood herein that “g” or “gm” is a reference to the gram weight unit and “° C.” is a reference to the Celsius temperature unit.

### BRIEF DESCRIPTION OF THE FIGURES

In drawings which illustrates embodiments of the present invention;

FIG. 1 is a comparative Power Ragone of coin cells battery for the binder PVDF-TFE-PP and PVDF-HFP of diethylmethylsulfonium-TFSI+1 m LiTFSI at 60° C.,

FIG. 2 illustrates examples of the normalized cycling stability of coin cells batteries mounted with an anode prepared with a nanosize Li₄Ti₅O₁₂ material using the PVDF-TFE-PP and PVDF-HFP binder. The examples were performed using the molten salt ethylmethylimidazolium-TFSI+1 m LiTFSI at 25° C.,

FIG. 3A represents an electron microscopy photograph which illustrates the characterization dispersion with nanotitanate PVDF-TFE-PP binder,

FIG. 3B is a larger view of the photograph of FIG. 3A,

FIG. 3C represents an electron microscopy photograph which illustrates the characterization dispersion with nanotitanate PVDF-HFP (i.e. PVDF) binder,

FIG. 3D is a larger view of the photograph of FIG. 3C, and;

FIG. 4 illustrates examples of the normalized cycling stability of coin cells batteries mounted with an anode prepared with a micro size Li₄Ti₅O₁₂ material using the PVDF-TFE-PP and PVDF-HFP binder. The examples are for the molten salt Ethylmethylimidazolium-TFSI+1 m LiTFSI at 25° C.

### DETAILED DESCRIPTION OF THE INVENTION

In view to qualify the binder, the onium has particularly been chosen from N,N′-alkyl-imidazolium, tetraalkylammonium and trialkylsulfonium, with alkyls substituents particularly containing 1 to 3 carbon atoms and such as counter anion of the onium is (FSO₂)₂N⁻ or/and (CF₃SO₂)₂N⁻, and wherein metallic salt is (FSO₂)₂NLi or/and (CF₃SO₂)₂NLi.

First of all, a film of PVDF-HFP copolymer Poly(vinylidene fluoride-co-hexafluoropropylene), produced by Solvay (Solef® 20810/1001) and a film of Poly(tetrafluoroethylene-co-vinylidene fluoride-co-polypropylene), named PVDF-TFE-PP, obtained from Aldrich (56% wt TFE and 27% wt VDF) have been respectively placed in a solution of widely used N-methyl-N′-ethyl-imidazolium·TFSI. After 24 hours at 80° C., the PVDF-HFP copolymer present an uptake of ionic liquids>20% wt while the PVDF-TFE-PP present almost no uptake of solvent. This insolubility in the imidazolium based ionic liquids is an important property for a binder and a strong argument in favor of the described binders.

In view to evaluate the influence of the binder on power characteristic of the battery with a Ragone plot, one with a LiCoO₂ cathode (2.5 C/cm²) using PVDF-HFP, such as disclosed herein, and a Li₄Ti₅O₁₂ anode (2 C/cm²) using PVDF-HFP, as disclosed herein, was compared with an equivalent battery using PVDF-TFE-PP binder instead of PVDF-HFP. The battery was assembled with a paper separator and used diethyl-methyl-sulfonium·TFSI with 1 M LiTFSI as the electrolyte.

It appears as described in the following Ragone plot that the power capability of the battery at 60° C. is strongly improved with PVDF-TFE-PP binder, especially considering that the capacity of both cathode at C/20 rate and 25° C. are equivalent.

A general procedure to prepare anode and cathode electrodes is provide in example 2 and 3 with PVDF-HFP copolymer, those electrodes was used as reference electrodes to qualify alternative binders.

### EXAMPLE 1

Film of PVDF-HFP copolymer Poly(vinylidene fluoride-co-hexafluoropropylene), produced by Solvay (Solef® 20810/1001) and a film of Poly(tetrafluoroethylene-co-vinylidene fluoride-co-polypropylene), named PVDF-TFE-PP, obtained from Aldrich (56% wt TFE and 27% wt VDF) have been respectively placed in a solution of 1-Ethyl-3-methylimidazolium bis(trifluoromethylsulfonyl)imide. After 24 hours at 80° C., the PVDF-HFP copolymer present an uptake of ionic liquids>20% wt while the PVDF-TFE-PP present negligible (<2% wt) uptake of solvent. This insolubility in ionic liquids is an important property for a binder and a strong argument in favor of the described binders.

### EXAMPLE 2

The following example described the general electrode preparation procedure. 85 gr of LiCoO₂ (approx. 5 μm diameter) and 10 gr of carbon black (CPChem, Shawinigan Black®) were thoroughly mixed in an agate crusher with the equivalent of 5 gr Poly(vinylidene fluoride-co-hexafluoropropylene), produced by Solvay (Solef® 20810/1001), dissolved in NMP at 4% wt concentration. 125 ml of NMP were also added to adjust the viscosity of the solution for coating. After crushing up to obtain a dispersed mixture, characterized with a Gardco®) fineness of grind gages, this past was coated on a 20 μm dual side coated conductive aluminum (Intellicoat, Product Code 2651), with a Gardco® universal blade applicator of 7 mils gate clearance. After evaporation of the solvent in air, the cathode electrode (85% wt LiCoO₂, 10% wt carbon and 50% wt binder) was dried under vacuum at 60° C. during 24 hours and store under Helium in a glove box. The film has a thickness of ≈47 μm and a porosity of 152%. This electrode has a 2 C/cm² reversible capacity. Depending on the composition of the coating mixture, clearance of the blade, it is possible to obtain electrode with a thickness comprise between 10 and 100 μm and porosity comprise between 100 and 300%. Porosity is adjusted if necessary by lamination or compression on a carver press.

### EXAMPLE 3

An anode of 30-50 nm lithium titanate spinel Li₄Ti₅O₂ (Altair Nanomaterials Inc.) was prepared with the same composition (85% wt Li₄Ti₅O₁₂, 10% wt carbon and 5% wt binder) as in example 2. The past was coated on a 20 μm dual side coated conductive aluminum (Intellicoat, Product Code 2651), with a 12 mils gate clearance of the blade applicator. After drying as in example 1, a film of 50 μm and 209% porosity was obtained. This film has a 2.5 C/cm² reversible capacity. Depending on the composition of the coating mixture, clearance of the blade, it is possible to obtain electrode with a thickness comprise between 10 and 100 μm and porosity comprise between 100 and 300%. Porosity is adjusted if necessary by lamination or compression on a carver press.

### EXAMPLE 4

Two coins cells batteries were assembled, first one with a LiCoO₂ cathode (≈2 C/cm²) using PVDF-HFP, such as disclosed in example 2, and a Li₄Ti₅O₁₂ anode (≈2.5 C/cm²) using PVDF-HFP, as disclosed in example 3, and a second equivalent one using PVDF-TFE-PP binder, as described in example 1, instead of PVDF-HFP. The two batteries were assembled with a 20 μm porous paper separator (alkylated cellulose) previously soaked in an electrolyte solution composed of diethyl(methyl)sulfonium bis(trifluoromethyl-sulfonyl)imide ionic liquid containing 1 Mol/kg LiTFSI. Those batteries tests at 25° C. in slow scan voltammetry (C/20) between 1.5 and 2.6 V vs Li⁺/Li⁰ presents similar capacities.

The coin cells was charged at a rate of C/3 and maintained at 2.6 Volts for 2.5 hours. The discharge rate in stability test was 1 C.

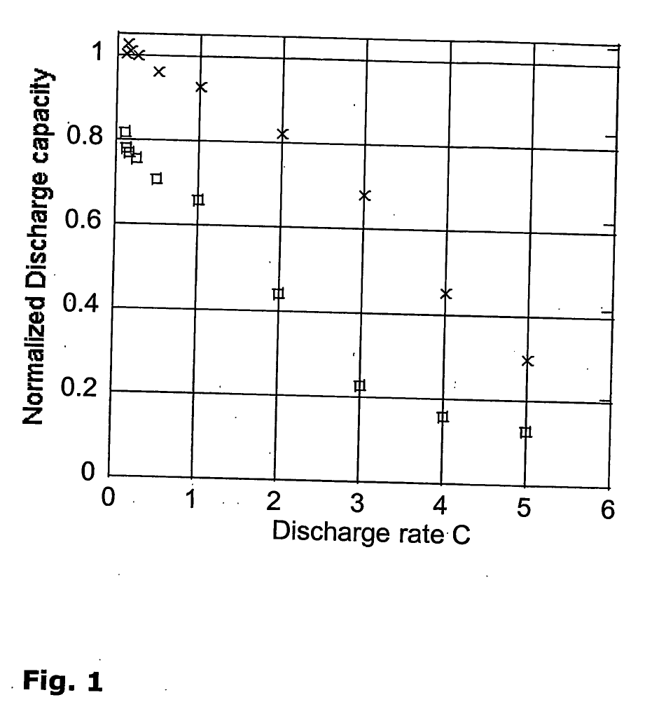

It appears as described in FIG. 1 Ragone plot that the power capability of the battery at 60° C. is improved with PVDF-TFE-PP binder, especially considering that the capacity of both cathode at C/20 rate and 25° C. are equivalent.

### EXAMPLE 5

In view to evaluate the influence of the binder on power characteristic of the battery with a Ragone plot, one with a LiCoO₂ cathode (2.5 C/cm²) using PVDF-HFP, such as disclosed in example 2, and a Li₄Ti₅O₁₂ anode (2 C/cm²) using PVDF-HFP, as disclosed in example 3, was compared with an equivalent battery using PVDF-TFE-PP binder instead of PVDF-HFP. he battery was assembled with a paper separator and used diethyl-methyl-sulfonium-TFSI with 1 M LITFSI as the electrolyte.

It appears as described in the Ragone plot of FIG. 1 that the power capability of the battery at 60° C. is strongly improved with PVDF-TFE-PP binder, especially considering that the capacity of both cathode at C/20 rate and 25° C. are equivalent.

### EXAMPLE 6

Two coins cells batteries were assembled, first one with a LiCoO₂ cathode (≈2 C/cm²) using PVDF-HFP, such as disclosed in example 2, and a Li₄Ti₅O₁₂ anode (≈2.5 C/cm²) using PVDF-HFP, as disclosed in example 3, and a second equivalent one using PVDF-TFE-PP binder, as described in example 1, instead of PVDF-HFP. The two batteries were assembled with a 20 μm porous paper separator (alkylated cellulose) previously soaked in an electrolyte solution composed of ethyl(methyl)imidazolium bis(trifluoromethylsulfonyl)-imide ionic liquid containing 1 Mol/kg LiTFSI. Those batteries tests were performed at 25° C. in slow scan voltammetry (C/20) between 1.5 and 2.6 V vs Li⁺/Li⁰ and presents similar capacities.

The coin cells was charged at a rate of C/3 and maintained at 2.6 Volts for 2.5 hours. The discharge rate in stability test was 1 C.

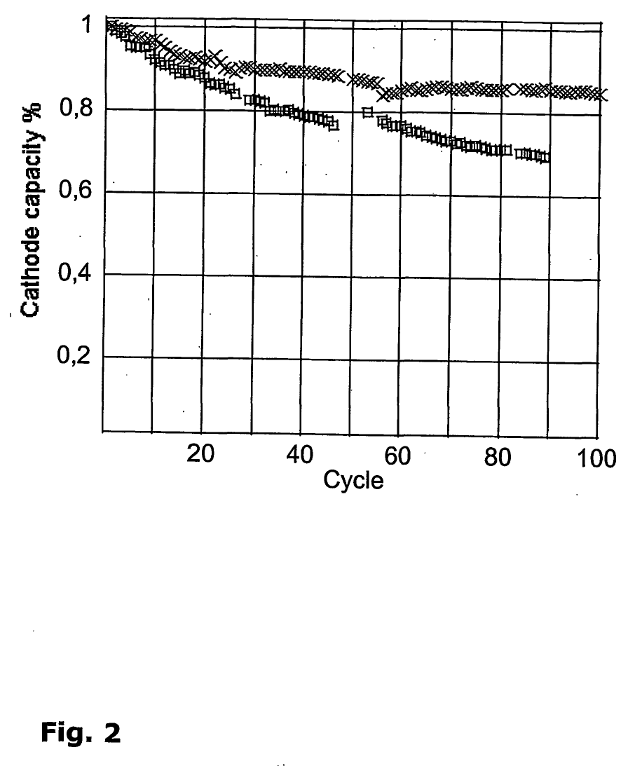

It appears as described in FIG. 2 that batteries made from a nanotitanate (e.g., Li₄Ti₅O₁₂ (≈30 to 50 nm)) and the PVDF-TFE-PP has a long-term cycling stability improved over a similar battery comprising the PVDF-HFP.

### EXAMPLE 7

Two soft cells batteries were assembled, first one with a LiCoO₂ cathode (≈2 C/cm²) using PVDF-HFP, such as disclosed in example 2, and a Li₄Ti₅O₁₂ anode (≈2.5 C/cm²) using PVDF-HFP, as disclosed in example 4, and a second equivalent one using PVDF-TFE-PP binder, as described in example 1, instead of PVDF-HFP. The two batteries were assembled with a 20 μm porous paper separator (alkylated cellulose) previously soaked in an electrolyte solution composed of ethyl(methyl)imidazolium bis(fluoromethylsulfonyl)-imide ionic liquid containing 1 Mol/kg LiTFSI. Those batteries tests were performed at 25° C. in slow scan voltametry (C/20) between 1.5 and 2.6 V vs Li⁺/Li⁰ and presents similar capacities.

The coin cells was charged at a rate of C/3 and maintained at 2.6 Volts for 2.5 hours. The discharge rate in stability test was 1 C.

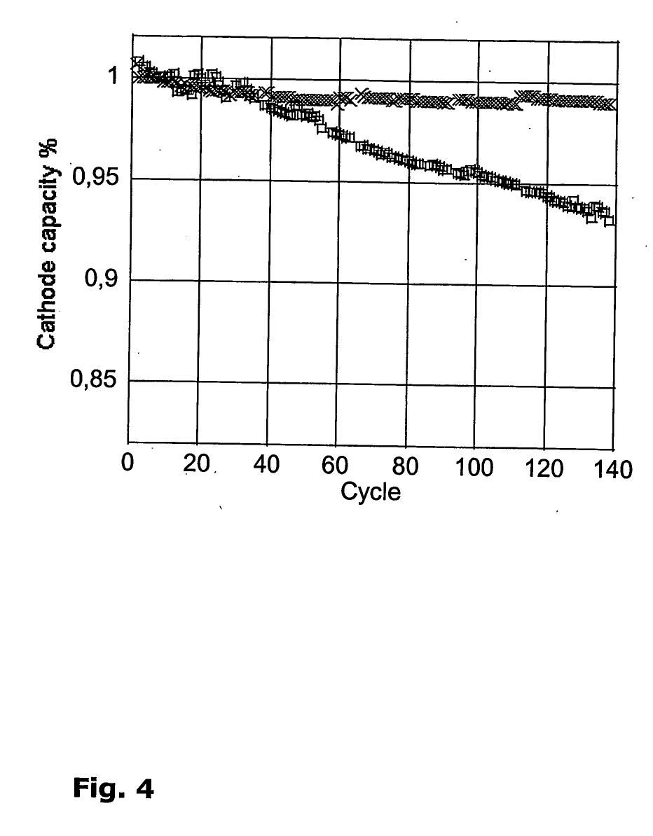

It appears as described in FIG. 4 that batteries made from a microtitanate (e.g., Li₄Ti₅O₁₂≈1 to 30 μm) and the PVDF-TFE-PP has a long-term cycling stability improved over a similar battery comprising the PVDF-HFP.

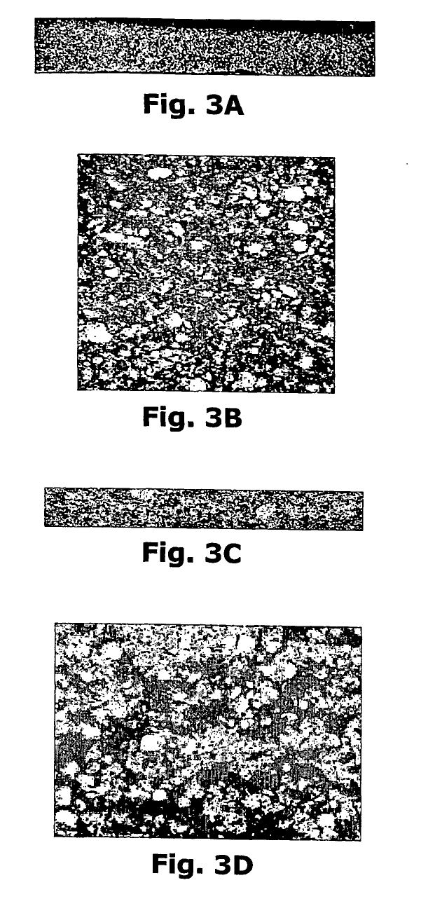

FIGS. 3A to 3D represent electron microscopy photographs which illustrates the dispersion with nanotitanate PVDF-TFE-PP binder and PVDF-HFP (i.e, PVDF). These photographs indicate that PVDF-TFE-PP has a better dispersion than PVDF-HFP. Therefore an anode using terpolymer of [(—CH₂CF₂—)_{x′}(—CF₂CF₂—)_{y′}[—CH₂CH(R)—]_{z′}]ₘ as sold by Aldrich under the reference 455,458-3 (CAS 54675-89-7) present an improved dispersion of active material relatively to a PVDF based electrodes.

1. An electrode material comprising:
one electroactive compound;
one carbonaceous conductivity enhancer; and
one polymeric binder of formula [(—CH₂CF₂—)_{x′}(—CF₂CF₂—)_{y′}[—CH₂CH(R)—]_{z′}]ₘ wherein:
x′+y′+z′=1, provided that only one x′, y′ or z′ could be simultaneously equal to zero.
R is an alkyl radical CₙH₂ₙ₊₁— with 0≦n≦8, and
10≦m≦10⁶.

2. The electrode material of claim 1 wherein x′, y′ and z′ are comprised between 0.05 and 0.95.

3. The electrode material of claim 2 wherein (—CF₂CF₂—) account for 45-65% wt, (—CF₂CH₂—) account for 15-35% wt, [—CH₂CH(R)—] account for 5-25% wt and R is H or CH₃.

4. The electrode material of claim 1 wherein x′ or y′ or z′ equal zero.

5. The electrode material of claim 4 wherein x′ or y′=0 and z′ is comprised between 0.05 and 0.95.

6. The electrode material of claim 5 wherein R is H or CH₃ and [—CH₂CH(R)—] account for 10-90% wt.

7. The electrode material of claim 4 wherein z′=0 and x′ is comprised between 0.05 and 0.95.

8. The electrode material of claim 7 wherein R is H or CH₃ and (—CF₂CF₂—) account for 10-90% wt.

9. The electrode material of claim 1 wherein the electroactive compound inserts and releases lithium cation at potential≦2 Volts vs Li⁺/Li0.

10. The electrode material of claim 9 wherein the electroactive compound is an oxide comprising a titanium spinel Li_{4x+3y}Ti₅₋ₓO₁₂ wherein 0≦x, y≦1, or an oxide Li[Ti_{1.67}Li_{0.33-y}M_{y}]O₄ wherein 0≦y≦0.33 and wherein M=Mg and/or Al in which the M cations are partially replaced by one or more suitable monovalent, divalent, trivalent or tetravalent metal M′ cations to provide an electrode Li[Ti_{1.67}Li_{0.33-y}M_{y-z}M′_{z}]O₄ in which z<y, or a double nitride of a transition metal and lithium comprising Li₃₋ₓCo₂N wherein 0≦x≦1 or having a structure of the antifluorite type comprising Li₃FeN₂ or Li₇MnN₄, or MoO₂, or WO₂, or mixtures thereof.

11. The electrode material of claim 1 wherein the electroactive compound inserts and releases lithium cation at potential≧2 Volts vs Li⁺/Li0.

12. The electrode material of claim 11 wherein the electroactive compound is a double oxide of cobalt and lithium optionally partially substituted of general formula Li₁ₐCo_{1-x+y}NiₓAl_{y}O₂ wherein 0<x+y<1; 0<y<0.3; 0<a<1, or Li_{y}N_{1-x-z}CoₓAl_{z}O₂ wherein 0≦x+y≦1 and 0≦y≦1, or a manganese spinel Li₂Mn₂₋ₓMₓO₄ wherein M is Cr, Al, V, Ni; 0≦x≦0.5, or a double phosphate of the Olivine or Nasicon structure comprising Li₁₋ₐFe₁₋ₓMnₓPO₄ and Li₁₋ₓ₊₂ₐFe₂P₁₋ₓSiₓO₄ wherein 0<x, a<1, or LiCoPO₄ wherein Co is substituted by one or more suitable metal cation, or LiNiO₂ wherein Ni is substituted by one or more suitable metal cation, or a mixtures thereof.

13. The electrode material of claim 9 wherein the electroactive compounds has a mean diameter size of between 10 nm to 30 μm.

14. The electrode material of claim 1 wherein the carbonaceous conductivity enhancer is carbon black or graphite in powder or fiber form, or a mixture thereof.

15. The electrode material of claim 14 wherein the conductivity enhancer has a mean diameter of between 10 nm and 30 μm.

16. The electrode material of claim 9 wherein the electroactive material accounts for 45 to 95% wt, the carbonaceous carbon additive accounts for 3 to 30% wt and the polymeric binder accounts for 3 to 30% wt.

17. The electrode material of claim 16 wherein the porosity of the electrode is between 30 and 300%.

18. The electrode material of claim 17 wherein the porosity is adjusted by further lamination process.

19. The electrode material of claim 1 wherein the electrode is prepared by coating technology from a suspension of components in a solvent, or a mixture of solvent, in which the polymeric binder is soluble.

20. The electrode material of claim 19 wherein the electrode material is coated on a current collector especially aluminum.

21. An electrochemical generator having at least one electrode material from claim 1.

22. The electrochemical generator of claim 21 having one positive electrode according to claim 11, one negative electrode according to claim 9, and one separator placed between the two electrodes and wherein both porous electrodes and separator are filled by an organic ionic liquids electrolyte, wherein said electrolyte is an electrolytic combination of:
at least one ionic compound having one cation of the onium type with at least one heteroatom comprising N, O, S or P bearing a positive charge and the anion including, in whole or in part, at least one imide ion choose from (FSO₂)₂N⁻and (CF₃SO₂)₂N⁻, or a mixtures thereof; and
at least one other component comprising a metallic salt and eventually an aprotic co-solvent with a boiling point>150° C.

23. The electrochemical generator of claim 22 wherein the separator is a porous polymer matrix or a gel formed between a polymer and the organic ionic liquids electrolyte.

24. The electrochemical generator of claim 22 wherein the onium is choose from ammonium (R₄N⁺), phosphonium (R₄P⁺), oxonium (R₃O⁺), sulfonium (R₃S⁺), guanidinium [(R₂N)₃C⁺], amidinium [(R₂N)₂C⁺R′], imidazolium [(RN)₂(CR′)₃], pyrazolium [(RN)₂(CR′)₃], pyrolidinium [(R₂N(CR′)₃] or a mixture thereof, and wherein:
R, R₂, R₃, and R₄ and are independently choose from:
a linear, branched or cyclic alkyl, alkenyl, oxaalkyl, oxaalkenyl, azaalkyl, azaalkenyl, thiaalkyl, thiaalkenyl, or dialkylazo group comprising from 1 to 18 atoms;
a cyclic or heterocyclic aliphatic radical of from 4 to 26 carbon atoms optionally comprising at least one lateral chain comprising one or more heteroatoms;
an aryl, arylalkyl, alkylaryl and alkenylaryl group of from 5 to 26 carbon atoms optionally comprising one or more heteroatoms in the aromatic nucleus;
groups comprising aromatic or heterocyclic nuclei, condensed or not, optionally comprising one or more atoms of nitrogen, oxygen, oxygen, sulfur or phosphorus;
and wherein two adjacent groups R can form a cycle or a heterocycle of from 4 to 9 carbon atoms, and wherein one or more R groups on the same cation can be part of polymeric chain;
and wherein R′ is H or R as defined above.

25. The electrochemical generator of claim 22 wherein the metallic salt is LiN(FSO₂)₂ or LiN(CF₃SO₂)₂.

26. A polymeric binder of formula [(—CH₂CF₂—)_{x′}(—CF₂CF₂—)_{y′}[—CH₂CH(R)—]_{z′}]ₘ wherein:
x′+y′+z′=1, provided that only one x′, y′ or z′ could be simultaneously equal to zero,
R is an alkyl radical CₙH₂ₙ₊₁ with 0≦n≦8,
10≦m≦10⁶,
wherein polymeric binder swelling in an organic ionic liquids is less than 5%.

27. The polymeric binder of claim 26, its swelling in an organic ionic liquids is less than 2%.

28. The polymeric binder of claim 26 wherein the polymer is such as (—CF₂CF₂) account for 45-65% wt, (—CF₂CH₂—) account for 15-35% wt, [—CH₂CH(R)—] account for 5-25% wt and R is H or CH₃.
